(19) United States
(12) Patent Application Publication
(10) Pub. No.: US 2015/0263316 A1
(43) Pub. Date: Sep. 17, 2015

(54) SEALED BATTERY

(71) Applicant: HITACHI MAXELL, LTD., Osaka (JP)

(72) Inventors: Hiroshi Matsumoto, Ibaraki-shi (JP); Kenta Kogo, Ibaraki-shi (JP)

(73) Assignee: HITACHI MAXELL, LTD., Osaka (JP)

(21) Appl. No.: 14/640,498

(22) Filed: Mar. 6, 2015

(30) Foreign Application Priority Data
Mar. 17, 2014 (JP) 2014-053002

(51) Int. Cl. H01M 2/04; H01M 2/02

(52) U.S. Cl. CPC H01M 2/0469; H01M 2/0207

(57) ABSTRACT

Provided is a sealed battery including a battery case which is obtained by welding an outer can and a lid plate to each other, in which the sealed battery has a configuration capable of obtaining both advantageous effects in which: the thickness of the battery case can be decreased to decrease the size of the battery; and a decrease in the weld strength between the outer can and the lid plate can be prevented.

The sealed battery includes a battery case in which an electrode body and an electrolytic solution are sealed. The battery case includes: a box-shaped outer can having an opening; and a lid plate that is welded to an edge portion of the opening in a state of covering the opening. In the lid plate, a thickness of an outer peripheral portion welded to the edge portion of the opening is greater than a thickness of a portion covering the electrode body.

### BACKGROUND OF THE INVENTION

1. Field of the Invention

The present invention relates to a sealed battery including a battery case which is obtained by welding an outer can and a lid plate to each other.

2. Description of the Related Art

In the related art, a sealed battery including a battery case is known, the battery case including: an outer can having an opening; and a lid plate that is fixed to the outer can by welding in a state of being disposed to cover the opening. In such a sealed battery, for example, as disclosed in JP-A-2003-31186, the battery case is configured by welding an outer peripheral portion of a battery lid (lid plate) to an edge portion of an opening of a battery can (outer can).

As disclosed in JP-A-2003-31186 and JP-A-2007-157519, the welding between the edge portion of the opening of the battery can (outer can) and the outer peripheral portion of the battery lid (lid plate) is generally performed by laser welding. When a joint portion between the edge portion of the opening of the battery can (outer can) and the outer peripheral portion of the battery lid (lid plate) is irradiated with laser beams, the edge portion of the opening and the outer peripheral portion of the battery lid (lid plate) are melted due to heat of the laser beams and then cooled so as to join them together.

### DISCLOSURE OF THE INVENTION

However, when the outer can and the lid plate are melted by laser beams to join them together as in the configurations disclosed in JP-A-2003-31186 and JP-A-2007-157519, it is necessary to increase the thicknesses of the outer can and the lid plate to a degree to which a hole is not formed on a component by the laser beams.

On the other hand, recently, the capacity of a battery has increased along with the wide use of an electronic apparatus such as a portable device. Therefore, it is required that the size of an electronic apparatus be reduced to reduce the size of a battery. That is, an increase in capacity and a decrease in size are required for a battery.

As a method for solving these requirements, a method of decreasing the thickness of a battery case as small as possible to increase the size of an electrode body as large as possible can be considered. However, when the thickness of the battery case is decreased as described above, a hole may be formed on a component, or the weld strength may be decreased due to laser beams at a welding portion of the outer can and the lid plate.

An object of the present invention is to provide a sealed battery including a battery case which is obtained by welding an outer can and a lid plate to each other, in which the sealed battery has a configuration capable of obtaining both advantageous effects in which: the thickness of the battery case can be decreased to decrease the size of the battery; and a decrease in the weld strength between the outer can and the lid plate can be prevented.

A sealed battery according to an embodiment of the present invention includes a battery case in which an electrode body and an electrolytic solution are sealed. The battery case includes: a box-shaped outer can having an opening; and a lid plate that is welded to an edge portion of the opening in a state of covering the opening. In the lid plate, a thickness of an outer peripheral portion welded to the edge portion is greater than a thickness of a portion covering the electrode body.

In the sealed battery according to the embodiment, in the lid plate covering the opening of the outer can, the thickness of the outer peripheral portion is greater than the thickness of the portion covering the electrode body. As a result, the size of the entire battery can be decreased, and concurrently a decrease in the weld strength between the outer can and the lid plate can be prevented.

### BRIEF DESCRIPTION OF THE DRAWINGS

FIG. 1 is a perspective view showing a schematic configuration of a sealed battery according to Embodiment 1.

FIG. 2 is a perspective view showing an internal structure of the sealed battery after cutting out a part of a lid plate of the sealed battery.

FIG. 3 is a cross-sectional view taken along line III-III of FIG. 1.

FIG. 4 is a cross-sectional view taken along line IV-IV of FIG. 1.

FIG. 5 is a cross-sectional view taken along line V-V of FIG. 2.

FIG. 6 is a schematic diagram showing a state where an outer can and a lid plate are welded to each other.

FIG. 7 is a cross-sectional view, which corresponds to FIG. 5, showing a sealed battery according to Embodiment 2.

FIG. 8 is a cross-sectional view, which corresponds to FIG. 5, showing a sealed battery according to Embodiment 3.

FIG. 9 is a cross-sectional view, which corresponds to FIG. 5, showing a sealed battery according to Embodiment 4.

FIG. 10 is a cross-sectional view, which corresponds to FIG. 5, showing a state where a groove is formed on an outer peripheral portion of a lid plate of the sealed battery according to Embodiment 4.

### DETAILED DESCRIPTION OF THE PREFERRED EMBODIMENTS

A sealed battery according to an embodiment of the present invention includes a battery case in which an electrode body and an electrolytic solution are sealed. The battery case includes: a box-shaped outer can having an opening; and a lid plate that is welded to an edge portion of the opening in a state of covering the opening. In the lid plate, a thickness of an outer peripheral portion welded to the edge portion is greater than a thickness of a portion covering the electrode body (first configuration).

As a result, in the lid plate, the thickness of the outer peripheral portion welded to the outer can be increased. Therefore, the formation of a hole on a welding portion between the outer can and the lid plate due to laser beams can be prevented, and a decrease in weld strength, which may be caused when the welding is performed at a laser intensity at which the hole is not formed, can be prevented. Moreover, in the lid plate, the thickness of the portion covering the electrode body is less than the thickness of the outer peripheral portion. Therefore, the size of the entire battery can be reduced while securing the battery capacity. Accordingly, the thickness of the lid plate can be decreased to decrease the size of the sealed battery, and a decrease in the weld strength between the outer can and the lid plate can be prevented.

In addition, as described above, by adjusting the thickness of the outer peripheral portion of the lid plate to be greater than the thickness of the portion covering the electrode body, the rigidity of the lid plate can be improved. As a result, when the lid plate is disposed on the opening of the outer can, the lifting of the lid plate, for example, can be prevented. Accordingly, when the lid plate is welded to the outer can, heat conduction is improved, and thus the lid plate can be easily welded to the outer can.

In the first configuration, in the lid plate, the thickness of the outer peripheral portion is greater than a thickness of a portion extending from the outer peripheral portion to the center side (second configuration). As a result, the thickness of a portion of the lid plate other than the outer peripheral portion can be decreased, and thus the size of the entire battery can be decreased.

In the first configuration, the thickness of the outer peripheral portion of the lid plate is greater than a penetration depth of a welding portion between the lid plate and the outer can (third configuration). As a result, when the outer peripheral portion of the lid plate is welded to the edge portion of the opening of the outer can, the formation of a hole due to the melting of the outer peripheral portion of the lid plate, and a decrease in the weld strength can be more reliably prevented.

In the first configuration, in the lid plate, a concave portion is formed on a surface positioned inside the battery case such that the thickness of the outer peripheral portion is greater than the thickness of the portion covering the electrode body (fourth configuration).

As a result, the concave portion is formed on the surface of the lid plate positioned inside the battery case, and thus a space for accommodating the electrode body can be secured in the battery case. Accordingly, the size of the entire battery can be decreased, and the battery capacity can be secured.

In the fourth configuration, on the surface of the lid plate positioned inside the battery case, a tapered portion is formed between the outer peripheral portion and the portion extending from the outer peripheral portion to the center side such that the thickness of the lid plate increases toward the outer peripheral portion (fifth configuration).

As a result, when the outer peripheral portion of the lid plate is welded to the edge portion of the opening of the outer can, the conduction of heat of the welding portion to the center side of the lid plate can be prevented. Moreover, with the above-described configuration, when the outer peripheral portion of the lid plate is welded to the edge portion of the opening of the outer can, the protrusion of a molten portion from the lid plate can be prevented. That is, the welding portion between the outer peripheral portion of the lid plate and the edge portion of the outer can is formed in a cross-sectionally tapered shape such that the width thereof decreases along with an increase in welding depth. Accordingly, by providing the above-described tapered portion along the shape of the welding portion, the protrusion of a molten portion from the lid plate can be prevented.

In the first configuration, the battery case has a flat shape in which a pair of opposite surfaces are formed to be wider than other surfaces. The opening is formed on one of the pair of surfaces in the battery case. The lid plate is fixed to the outer can by welding so as to configure the opening-formed surface of the battery case (sixth configuration).

As described above, when the opening is provided on the wide surface of the flat-shaped outer can and is covered with the lid plate, the thickness of the lid plate greatly affects the inner volume of the battery case. Therefore, by adjusting the lid plate to be thin as in the above-described first configuration, the size of the entire battery can be decreased while securing the battery capacity.

Further, in the above-described configuration, the welding range between the edge portion of the opening of the outer can and the outer peripheral portion of the lid plate is increased to be wider than that in a configuration of the related art where a lid plate is welded to an opening on the top surface of an outer can. By applying the above-described first configuration to such a configuration, a decrease in the weld strength between the outer can and the lid plate can be prevented. Accordingly, in the above-described configuration, due to the application of the above-described first configuration, far superior effects can be obtained in which: the size of the entire battery can be decreased; and a decrease in the weld strength between the outer can and the lid plate can be prevented.

In the first configuration, in the outer peripheral portion of the lid plate, a groove is formed on a surface positioned outside the battery case. In the lid plate, a portion extending from the groove to the outer periphery side is welded to the edge portion (seventh configuration).

As a result, heat generated during welding is not likely to be conducted to a portion of the lid plate extending from the groove to the inner periphery side. Accordingly, the heat is likely to be confined to the portion of the lid plate extending from the groove to the outer periphery side, and thus the outer peripheral portion of the lid plate can be easily melted. Accordingly, during welding, the edge portion of the opening of the outer can and the portion of the lid plate extending from the groove to the outer periphery side can be melted, and thus the weld strength between the outer can and the lid plate can be improved.

Moreover, as described above, by providing the groove on the surface of the lid plate and then welding the portion of the lid plate, which extends from the groove to the outer periphery side, to the edge portion of the opening of the outer can, a portion melted during welding can be prevented from being drawn to the inner periphery side of the lid plate. That is, since the groove is provided on the portion of the lid plate extending from the welding portion to the inner periphery side, the welding portion can be prevented from being applied with a tensile force from the inner periphery side of the lid plate when being hardened from the molten state. As a result, when a portion melted during welding is hardened, cracking can be prevented at a joint portion between the opening of the outer can and the outer peripheral portion of the lid plate.

In the first configuration, the outer can and the lid plate are welded to each other by laser beams (eighth configuration). In a case where the edge portion of the opening of the outer can is welded to the outer peripheral portion of the lid plate using laser beams, when the thickness of the lid plate is small, the weld strength may be decreased. On the other hand, due to the application of the first configuration, a decrease in the weld strength can be prevented.

Hereinafter, embodiments of the present invention will be described in detail with reference to the drawings. The dimensions of components in each drawing does not exactly reflect the actual dimensions of the components, the actual dimensional ratio of the components, and the like.

### EMBODIMENT 1

### Overall Configuration

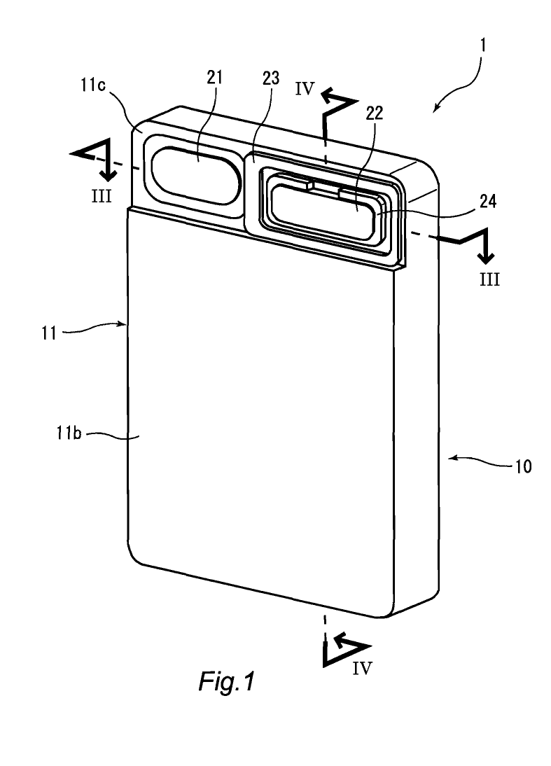

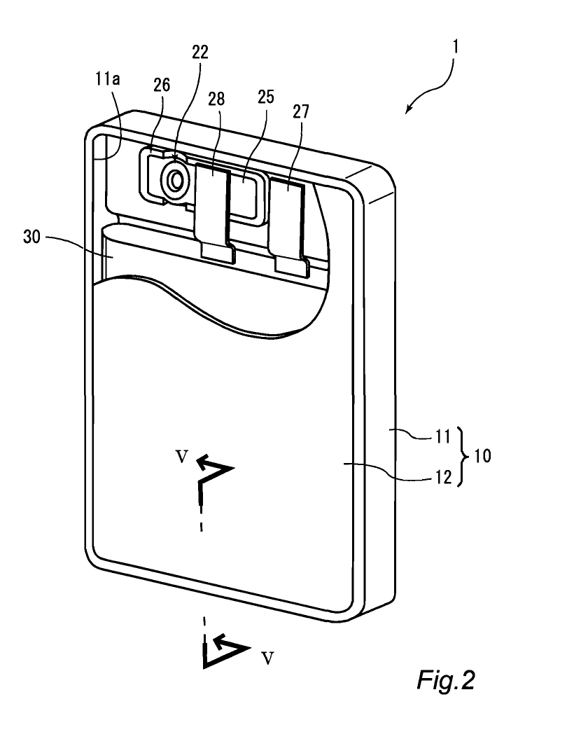

FIG. 1 is a perspective view showing a schematic configuration of a sealed battery 1 according to Embodiment 1 of the present invention. This sealed battery 1 includes: a cuboid-shaped battery case 10; and an electrode body 30 (refer to FIG. 2) and a nonaqueous electrolytic solution (not shown; hereinafter, referred to as “electrolytic solution”) that are sealed in the battery case 10. The sealed battery 1 is a secondary battery used as a power supply of an electronic apparatus such as a portable device.

In the battery case 10, a pair of opposite surfaces are formed to be wider than other surfaces. That is, the battery case 10 is formed in a flat shape in which the respective dimensions in a width direction (horizontal direction in FIGS. 1 and 2) and a height direction (vertical direction in FIGS. 1 and 2) are greater than the dimensions in a thickness direction (depth direction in FIGS. 1 and 2). Accordingly, among the side surfaces extending in the height direction in the battery case 10, a pair of opposite side surfaces (a pair of surfaces) are wider than the other surfaces. In the battery case 10 according to the embodiment, the dimensions in the height direction are greater than the dimensions in the width direction.

As shown in FIG. 2, the battery case 10 includes: a box-shaped outer can 11 having an opening on one of the pair of wide side surfaces; and a plate-shaped lid plate 12 that covers the opening 11a of the outer can 11.

In the outer can 11, the opening 11a is formed on one of the pair of wide side surfaces in the battery case 10. The lid plate 12 is fixed to the outer can 11 so as to cover the opening 11a and configure the opening-formed surface of the battery case 10. Although described below in detail, the outer peripheral portion of the lid plate 12 is welded to an edge portion 11f of the opening 11a of the outer can 11 by, for example, seam welding. The other one of the pair of wide side surfaces in the battery case 10 is configured by one side surface of the outer can 11. In FIG. 1, the other one of the pair of wide side surfaces in the battery case 10 (hereinafter, referred to as “wide surface of the outer can 11”) is represented by reference numeral 11b.

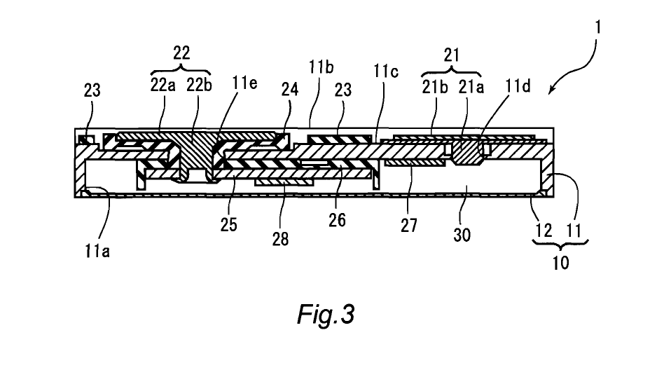

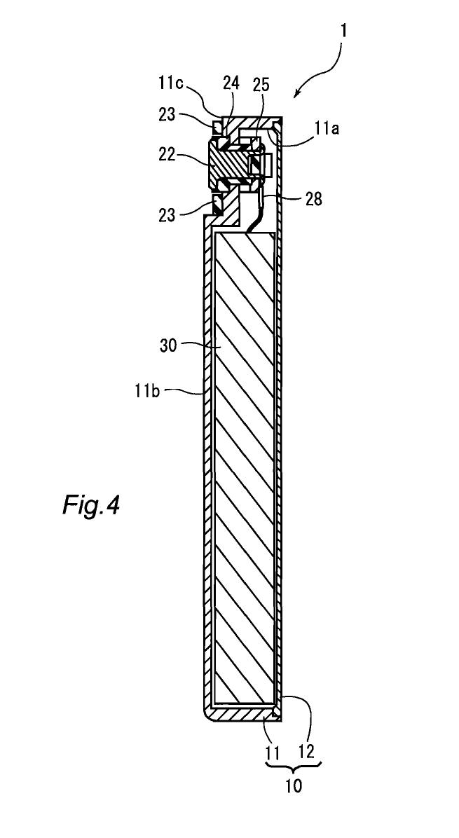

As shown in FIG. 1, a terminal mounting surface 11c is provided at a portion of the wide surface 11b of the outer can 11 in the height direction of the sealed battery 1. As shown in FIGS. 3 and 4, this terminal mounting surface 11c is formed stepwise so as to be positioned at a position closer to the opening 11a than the other portions of the wide surface 11b. Specifically, the terminal mounting surface 11c is offset to the opening 11a side of the outer can 11 relative to the other portions of the wide surface 11b such that terminals described below do not protrude from the other portions of the wide surface 11b in the thickness direction of the sealed battery 1 in a state of being disposed on the terminal mounting surface 11c. Accordingly, the thickness of the outer can 11 on the terminal mounting surface 11c is less than the thickness of the outer can 11 on the other portions of the wide surface 11b. The other portions of the wide surface 11b cover the electrode body 30.

As shown in FIG. 1, a positive electrode terminal 21 and a negative electrode terminal 22 are disposed on the terminal mounting surface 11c. Although described below in detail, the positive electrode terminal 21 is electrically connected to the battery case 10. On the other hand, as described below, the negative electrode terminal 22 is electrically connected to a negative electrode of the electrode body 30 through a pressing plate 25 and a negative electrode lead tab 28 (refer to FIG. 3). In addition, as described below, the negative electrode terminal 22 is electrically insulated from the battery case 10 through an insulator 24 and an insulating plate 26 (refer to FIG. 3).

As shown in FIG. 1, the positive electrode terminal 21 is disposed on the left side of the terminal mounting surface 11c when the terminal mounting surface 11c is seen in a front view. The negative electrode terminal 22 is disposed on the right side of the terminal mounting surface 11c when the terminal mounting surface 11c is seen in a front view. That is, the positive electrode terminal 21 and the negative electrode terminal 22 are disposed in parallel on the left and right sides of the terminal mounting surface 11c.

An insulator 23 is disposed on the terminal mounting surface 11c so as to surround the negative electrode terminal 22. By providing the insulator 23, short-circuiting between the negative electrode terminal 22 and the positive electrode terminal 21 and between the negative electrode terminal 22 and the outer can 11 can be prevented.

The internal structure of the sealed battery 1 including the positive electrode terminal 21 and the negative electrode terminal 22 will be described below in detail using FIGS. 3 and 4. FIG. 3 is a cross-sectional view taken along line III-III of FIG. 1. FIG. 4 is a cross-sectional view taken along line IV-IV of FIG. 1.

As shown in FIG. 3, the positive electrode terminal 21 includes: a plug portion 21a that blocks a through hole 11d formed on the terminal mounting surface 11c of the outer can 11; and a plate portion 21b that is connected to a base end of the plug portion 21a. The plug portion 21a is formed at the center of the plate portion 21b when the plate portion 21b is seen in a front view. As a result, as shown in FIG. 3, the positive electrode terminal 21 has a cross-sectionally T shape when taken as a whole.

The plate portion 21b of the positive electrode terminal 21 is formed by pressing two plate-shaped components in a state where they overlap each other. That is, the positive electrode terminal 21 is configured by a so-called clad material. The above-described plug portion 21a is formed integrally with a component positioned on the terminal mounting surface 11c side among the two plate-shaped components configuring the plate portion 21b. That is, the positive electrode terminal 21 is a component obtained by pressing planes of the plate-shaped component and the cross-sectionally T-shaped component together.

In the positive electrode terminal 21, it is preferable that the component including the plug portion 21a is formed of the same material (for example, aluminum or an aluminum alloy) as that of the outer can 11; and that the plate-shaped component positioned on the component including the plug portion 21a is formed of the same material (for example, nickel or a nickel alloy) as that of lead wire (not shown). As a result, the positive electrode terminal 21 having a high joining strength to the outer can 11 and a high joining strength to the lead wire can be obtained. Accordingly, the joining strength of the positive electrode terminal 21 to the outer can 11 and the lead wire can be improved.

The positive electrode terminal 21 is fixed in a state where the plug portion 21a is inserted into the through hole 11d formed on the terminal mounting surface 11c of the outer can 11. That is, in a state where the plug portion 21a is press-fitted into the through hole 11d of the terminal mounting surface 11c, the outer periphery side of the plate portion 21b is joined to the terminal mounting surface 11c by welding.

The through hole 11d formed on the terminal mounting surface 11c of the outer can 11 functions as an injection port through which the electrolytic solution is introduced into the battery case 10. As described above, by blocking the through hole 11d with the plug portion 21a of the positive electrode terminal 21, the leakage of the electrolytic solution from the inside of the battery case 10 can be prevented.

As shown in FIGS. 2 and 3, one end of a positive electrode lead tab 27 is connected to a positive electrode of the electrode body 30, and the other end of the positive electrode lead tab 27 is connected to the inner surface of the outer can 11. As a result, the positive electrode terminal 21 is electrically connected to the positive electrode of the electrode body 30 through the outer can 11 and the positive electrode lead tab 27.

The negative electrode terminal 22 is a component formed of, for example, copper, and includes a plate-shaped planar portion 22a and a cylindrical shaft portion 22b. The shaft portion 22b is formed at the center of the planar portion 22a when the planar portion 22a is seen in a front view. As a result, as in the case of the positive electrode terminal 21, the negative electrode terminal 22 also has a cross-sectionally T shape when taken as a whole. In the negative electrode terminal 22, the shaft portion 22b is formed integrally with the planar portion 22a.

The shaft portion 22b of the negative electrode terminal 22, and the cylindrical insulator 24 are inserted into a through hole 11e formed on the terminal mounting surface 11c of the outer can 11. Specifically, in a state where the shaft portion 22b is inserted into the insulator 24, the shaft portion 22b and the insulator 24 are inserted into the through hole 11e of the terminal mounting surface 11c of the outer can 11. In addition, the shaft portion 22b is fixed to the pressing plate 25 by being squashed in a state where a tip end of the shaft portion 22b is inserted into the pressing plate 25.

The insulating plate 26 is disposed between the pressing plate 25 and the inner surface of the outer can 11. This insulating plate 26 electrically insulates the pressing plate 25, which is electrically connected to the negative electrode terminal 22, and the outer can 11, which is electrically connected to the positive electrode terminal 21, from each other. The shaft portion 22b of the negative electrode terminal 22, and the cylindrical insulator 24 pass through the insulating plate 26. As a result, an edge portion of the through hole 11e of the outer can 11 is covered with the insulator 24 and the insulating plate 26. Accordingly, short-circuiting between the outer can 11, and the negative electrode terminal 22 and the pressing plate 25 can be prevented.

One end of the negative electrode lead tab 28 is connected to the negative electrode of the electrode body 30, and the other end of the negative electrode lead tab 28 is connected to the pressing plate 25. As a result, the negative electrode terminal 22 is electrically connected to the negative electrode of the electrode body through the pressing plate 25 and the negative electrode lead tab 28.

In the positive electrode, a positive electrode mixture layer is formed on a single surface or both surfaces of a belt-shaped positive electrode current collector. The positive electrode current collector is formed of, for example, a foil of aluminum, titanium, or the like, a plain-woven mesh, an expanded metal, a lath net, or a punching metal.

The positive electrode mixture layer is formed by mixing a positive electrode active material, a conductive auxiliary agent, and a binder with each other. As the positive electrode active material, for example, lithium manganese oxide, lithium nickel composite oxide, lithium cobalt composite oxide, lithium nickel cobalt composite oxide, vanadium oxide, or molybdenum oxide can be used. As the conductive auxiliary agent, for example, graphite, carbon black, or acetylene black can be used. As the binder, one binder or a mixture of two or more binders selected from polyimide, polyamide imide, polytetrafluoroethylene (PTFE), and polyvinylidene fluoride (PVDF) can be used.

In the negative electrode, a negative electrode mixture layer is formed on a single surface or both surfaces of a belt-shaped negative electrode current collector. The negative electrode current collector is formed of, for example, a foil of copper, nickel, stainless steel, or the like, a plain-woven mesh, an expanded metal, a lath net, or a punching metal.

The negative electrode mixture layer is formed by mixing a negative electrode active material and a binder with each other. As the negative electrode active material, for example, natural graphite, mesophase carbon, or amorphous carbon can be used. As the binder, one binder or a mixture of two or more binders selected from cellulose such as carboxymethyl cellulose (CMC) or hydroxypropyl cellulose (HPC); rubber binder such as styrene-butadiene rubber (SBR) or acrylic rubber; PTFE; or PVDF can be used.

A separator is formed of a porous film or non-woven fabric, for example, polypropylene (PP), polyethylene (PE), polyethylene terephthalate (PET), polybutylene terephthalate (PBT), or polyphenylene sulfide (PPS).

The electrolytic solution is a solution in which a lithium salt is dissolved in an organic solvent. As the organic solvent, one solvent or a mixture of two or more solvents selected from vinylene carbonate (VC), propylene carbonate (PC), ethylene carbonate (EC), butylene carbonate (BC), dimethyl carbonate (DMC), diethyl carbonate (DEC), methyl ethyl carbonate (MEC), or γ-butyrolactone can be used. As the lithium salt, for example, LiPF₆, LiBF₄, or LiN(CF₃SO₂)₂ can be used.

The positive electrode, the negative electrode, the separator, and the electrolytic solution are not limited to the above-described configurations, and any configurations can be adopted as long as the sealed battery 1 can be realized.

### Junction Structure of Outer Can and Lid Plate

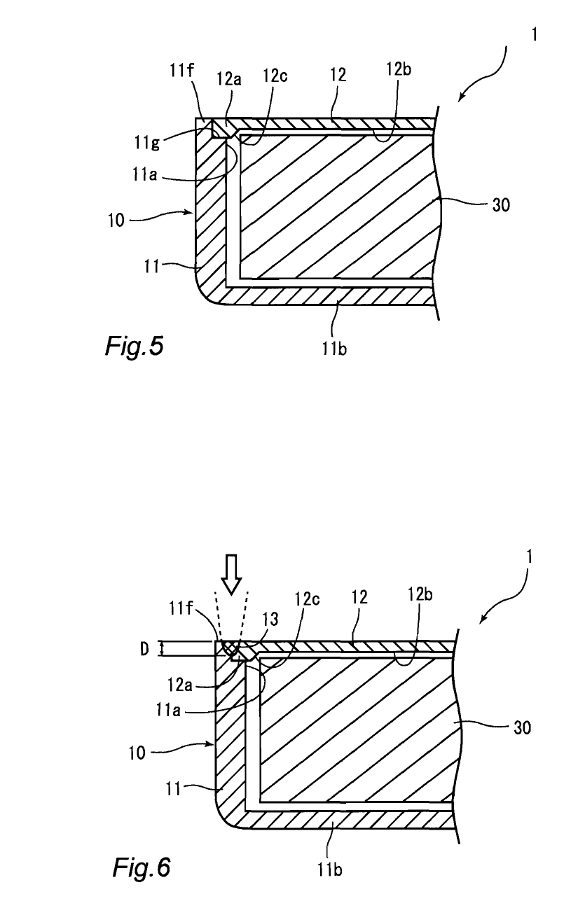

Next, in the sealed battery 1 having the above-described configuration, the junction structure of the outer can 11 and the lid plate 12 will be described in detail using FIGS. 5 and 6. FIG. 5 is a cross-sectional view taken along line V-V of FIG. 2. FIG. 6 is a diagram schematically showing a state where the outer can 11 and the lid plate 12 are welded to each other using laser beams. In the drawings other than FIG. 6, the welding portion between the outer can 11 and the lid plate 12 is not shown.

The configurations shown in FIGS. 5 and 6 may be applied to the entire range of the welding portion between the outer can 11 and the lid plate 12 of the sealed battery 1, or may be applied to a part of the welding portion. In addition, the structure shown in FIGS. 5 and 6 may be applied to a cross-section of the battery case 10 other than the cross-section taken along line V-V of FIG. 2.

As shown in FIG. 5, in the lid plate 12, the thickness of an outer peripheral portion 12a welded to the edge portion 11f of the opening 11a of the outer can 11 is greater than that of the center portion. That is, on a surface of the lid plate 12 positioned inside the battery case 10, a concave portion 12b is formed on a portion extending from the outer peripheral portion 12a to the center side.

When the lid plate 12 is seen in a plan view, the concave portion 12b may be formed in a rectangular shape as in the case of the lid plate 12, or may be formed in an elliptical shape or a circular shape. In addition, the concave portion 12b may be formed on the entire portion of the lid plate 12 extending from the outer peripheral portion 12a to the center side, or may be formed on only a portion of the lid plate 12 covering the electrode body 30. That is, in the lid plate 12, the concave portion 12b may be formed such that the thickness of the outer peripheral portion 12a is greater than the thickness of the portion extending from the outer peripheral portion 12a to the center side, or may be formed such that the thickness of the outer peripheral portion 12a is greater than the thickness of the portion covering the electrode body 30.

In the edge portion 11f of the opening 11a of the outer can 11, a notch portion 11g is formed inside the outer can 11. By providing the notch portion 11g in the edge portion 11f, the thickness of a wall configuring the edge portion 11f is made to be less than the thickness of the other portions. The lid plate 12 is formed in a size such that the outer peripheral portion 12a is positioned at the notch portion 11g of the outer can 11.

The lid plate 12 and the outer can 11 having the above-described configuration are partially melted using laser beams as shown in FIG. 6. As a result, the lid plate 12 and the outer can 11 are joined together. Specifically, a boundary portion between the outer peripheral portion 12a of the lid plate 12 and the edge portion 11f of the opening 11a of the outer can 11 is irradiated with laser beams (refer to a white arrow). As a result, a molten portion is formed at the boundary portion, and then a molten portion of the lid plate 12 and a molten portion of the outer can 11 are hardened. As a result, a welding portion 13 is formed. As shown in FIG. 6, this welding portion 13 is formed in a cross-sectionally tapered shape in which the width thereof decreases along with an increase in welding depth at the boundary portion between the outer peripheral portion 12a of the lid plate 12 and the edge portion 11f of the opening 11a of the outer can 11.

The thickness of the outer peripheral portion 12a of the lid plate 12 is greater than the penetration depth (D in FIG. 6) of the welding portion 13. As a result, when the outer peripheral portion 12a of the lid plate 12 is welded to the edge portion 11f of the opening 11a of the outer can 11, the formation of a hole on the outer peripheral portion 12a of the lid plate 12 can be prevented, and a decrease in weld strength, which may be caused when the welding is performed at a laser intensity at which the hole is not formed, can be prevented.

The outer peripheral portion 12a of the lid plate 12 is formed in a predetermined range from an outer peripheral end to the center of the lid plate 12 so as to protrude from an inner space of the outer can 11 in a state where the lid plate 12 is disposed to cover the opening 11a of the outer can 11.

As a result, a sufficient molten portion can be secured in the outer peripheral portion 12a of the lid plate 12. Accordingly, the weld strength between the outer peripheral portion 12a of the lid plate 12 and the edge portion 11f of the opening 11a of the outer can 11 can be secured.

In the lid plate 12, an inclined portion 12c (tapered portion) is formed on the outer periphery side of the concave portion 12b such that the thickness thereof gradually increases toward the outer peripheral portion 12a. By providing the inclined portion 12c, when the outer peripheral portion 12a of the lid plate 12 is welded to the edge portion 11f of the opening 11a of the outer can 11, heat conduction to the center of the lid plate 12 can be prevented, and a sufficient molten region can be secured in the outer peripheral portion 12a of the lid plate 12. As a result, when the outer peripheral portion 12a of the lid plate 12 is welded to the edge portion 11f of the opening 11a of the outer can 11, the outer peripheral portion 12a can be sufficiently melted. Accordingly, the weld strength between the outer peripheral portion 12a of the lid plate 12 and the edge portion 11f of the opening 11a of the outer can 11 can be improved.

In the embodiment, the thickness of the outer peripheral portion 12a of the lid plate 12 is adjusted to be greater than the thickness of the portion covering the electrode body 30. As a result, the size of the sealed battery 1 can be decreased as small as possible, and when the outer peripheral portion 12a of the lid plate 12 is welded to the edge portion 11f of the opening 11a of the outer can 11, the formation of a hole or a decrease in the weld strength can be prevented. That is, with the above-described configuration, the size of the sealed battery 1 can be reduced, and concurrently the weld strength can be secured.

Moreover, by providing the concave portion 12b on the surface of the lid plate 12 positioned inside the battery case 10, a space for accommodating the electrode body 30 can be secured. Accordingly, the battery capacity can be secured.

In addition, as described above, by adjusting the thickness of the outer peripheral portion 12a of the lid plate 12 to be greater than the thickness of the portion covering the electrode body 30, the rigidity of the lid plate 12 can be improved. As a result, when the lid plate 12 is disposed on the opening 11a of the outer can 11, the lifting of the lid plate 12, for example, can be prevented. Accordingly, when the lid plate 12 is welded to the outer can 11, heat conduction is improved, and thus the lid plate 12 can be easily welded to the outer can 11.

### EMBODIMENT 2

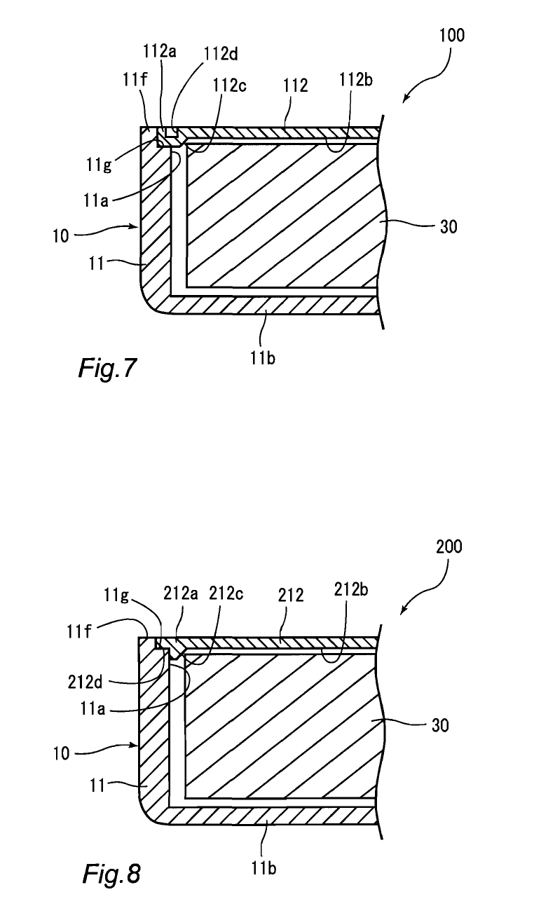

FIG. 7 is shows a junction structure of a lid plate 112 and the outer can 11 in a sealed battery 100 according to Embodiment 2 of the present invention. In this embodiment, the configuration of an outer peripheral portion 112a of the lid plate 112 is different from that of Embodiment 1. In the following description, components having the same configurations as those of Embodiment 1 are represented by the same reference numerals, and the description thereof will not be repeated. Only components having different configurations from those of Embodiment 1 will be described.

As shown in FIG. 7, in the embodiment, the thickness of the outer peripheral portion 112a of the lid plate 112 is greater than the thickness of the center portion of the lid plate 112 as in the case of Embodiment 1. In the embodiment, a cross-sectionally rectangular groove 112d is formed on a surface of the outer peripheral portion 112a positioned outside the battery case.

By providing the above-described groove 112d in the outer peripheral portion 112a of the lid plate 112, when the outer peripheral portion 112a of the lid plate 112 is welded to the edge portion 11f of the opening 11a of the outer can 11, heat diffusion to the center side of the lid plate 112 can be prevented. As a result, in the outer peripheral portion 112a of the lid plate 112, a portion extending from the groove 112d to the outer periphery side is sufficiently melted with heat generated during welding. Accordingly, the weld strength between the outer can 11 and the lid plate 112 can be improved.

Moreover, as described above, by providing the groove 112d on the surface of the lid plate 112 and then welding the portion of the lid plate 112, which extends from the groove 112d to the outer periphery side, to the edge portion 11f of the opening 11a of the outer can 11, a portion melted during welding can be prevented from being drawn to the inner periphery side of the lid plate 112. That is, since the groove 112d is provided on the portion of the lid plate 112 extending from the welding portion to the inner periphery side, the welding portion can be prevented from being applied with a tensile force from the inner periphery side of the lid plate 112 when being hardened from the molten state. As a result, when a portion melted during welding is hardened, cracking can be prevented at a joint portion between the outer can 11 and the lid plate 112.

In FIG. 7, reference numeral 112b represents a concave portion, and reference numeral 112c represents an inclined portion.

In the embodiment, the groove 112d provided in the outer peripheral portion 112a of the lid plate 112 has a cross-sectionally rectangular shape. However, the groove 112d is not limited to this shape and may have other cross-sectional shapes.

### EMBODIMENT 3

FIG. 8 is shows a junction structure of a lid plate 212 and the outer can 11 in a sealed battery 200 according to Embodiment 3 of the present invention. In this embodiment, the configuration of an outer peripheral portion 212a of the lid plate 212 is different from that of Embodiment 1. In the following description, components having the same configurations as those of Embodiment 1 are represented by the same reference numerals, and the description thereof will not be repeated. Only components having different configurations from those of Embodiment 1 will be described.

As shown in FIG. 8, the outer peripheral portion 211a having a greater thickness than that of the center portion is formed on the outer periphery side of the lid plate 212. In the outer peripheral portion 212a, a notch portion 212d is formed on an outer peripheral end of a surface positioned inside the battery case 10. This notch portion 212d contacts the notch portion 11g, which is formed on the edge portion 11f of the opening 11a, in a state where the lid plate 212 is disposed on the opening 11a of the outer can 11. At this time, in the outer peripheral portion 212a, the portion of the lid plate 212 extending from the notch portion 212d to the center side is positioned inside the outer can 11.

As a result, the outer peripheral portion 212a of the lid plate 212 and the edge portion 11f of the opening 11a of the outer can 11 can be sufficiently melted with heat generated during welding. Furthermore, in the outer peripheral portion 212a of the lid plate 212, the portion of the lid plate 212 extending from the notch portion 212d to the center side is positioned inside the outer can 11; as a result, the thickness of a portion of the lid plate 212 near the welding portion can be sufficiently secured. Accordingly, the formation of a hole due to the melting of the lid plate 212 during welding, and a decrease in the weld strength can be prevented.

In FIG. 8, reference numeral 212b represents a concave portion, and reference numeral 212c represents an inclined portion.

### EMBODIMENT 4

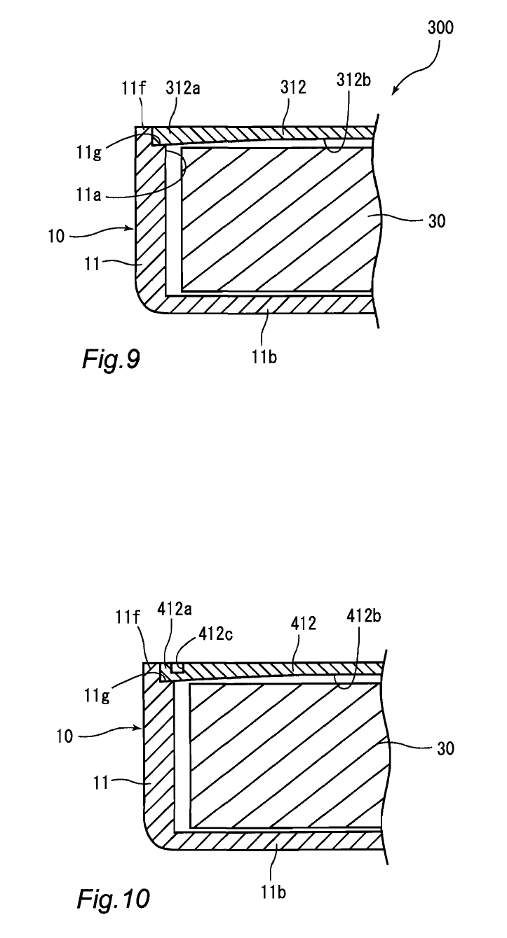

FIG. 9 is shows a junction structure of a lid plate 312 and the outer can 11 in a sealed battery 300 according to Embodiment 4 of the present invention. In this embodiment, the configuration of the lid plate 312 is different from that of Embodiment 1. In the following description, components having the same configurations as those of Embodiment 1 are represented by the same reference numerals, and the description thereof will not be repeated. Only components having different configurations from those of Embodiment 1 will be described.

As shown in FIG. 9, in the lid plate 312, a concave portion 312b is formed on a surface positioned inside the battery case 10 such that the thickness of an outer peripheral portion 312a is greater than the thickness of the center portion. The concave portion 312b is formed on the lid plate 312 such that the thickness of the lid plate 312 gradually decreases from the outer peripheral portion 312a to the center portion. As a result, a surface of the lid plate 312 positioned inside the battery case 10 is formed in a mortar shape.

With the above-described configuration, the thickness of the lid plate 312 can be decreased, and concurrently the weld strength between the outer peripheral portion 312a of the lid plate 312 and the edge portion 11f of the opening 11a of the outer can 11 can be secured.

As shown in FIG. 10, in an outer peripheral portion 412a of a lid plate 412, a groove 412c may be formed on a surface positioned outside of the battery case 10 as in the case of Embodiment 2. Accordingly, as in the configuration of Embodiment 2, the weld strength between the outer peripheral portion 412a of the lid plate 412 and the edge portion 11f of the opening 11a of the outer can 11 can be improved.

### OTHER EMBODIMENTS

Hereinabove, the embodiments of the present invention have been described. However, the above-described embodiments are merely examples for practicing the present invention. Accordingly, the present invention is not limited to the above-described embodiments, and various modifications can be made to the above-described embodiments within a range not departing from the scope of the present invention.

In each of the embodiments, the opening 11a is provided on the wide surface among the side surfaces of the battery case 10 so as to be covered with the lid plate 12, 112, 212, 312, or 412. However, an opening may be formed on a surface (for example, a top surface, a bottom surface, or other surfaces) other than the wide surface of the battery case 10 to be covered with the lid plate. The configuration of each of the embodiments may be applied to a junction structure of the edge portion of the opening and the outer peripheral portion of the lid plate.

In each of the embodiments, in the lid plate 12, 112, 212, 312, or 412, the thickness of the outer peripheral portion 12a, 112a, 212a, 312a, or 412a is formed to be greater than the thickness of the portion extending from the outer peripheral portion 12a, 112a, 212a, 312a, or 412a to the center side. However, any configuration can be adopted for the configuration of the lid plate as long as the thickness of the outer peripheral portion of the lid plate is greater than the thickness of the portion covering the electrode body 30.

In each of the embodiments, the battery case 10 of the sealed battery 1 has a cuboid shape. However, the battery case may have other shapes.

In each of the embodiments, the sealed battery 1 is a secondary battery. However, the sealed battery may be a primary battery.

What is claimed is:

1. A sealed battery comprising
a battery case in which an electrode body and an electrolytic solution are sealed,
wherein the battery case includes:
a box-shaped outer can having an opening; and
a lid plate that is welded to an edge portion of the opening in a state of covering the opening, and
in the lid plate, a thickness of an outer peripheral portion welded to the edge portion is greater than a thickness of a portion covering the electrode body.

2. The sealed battery according to claim 1,
wherein in the lid plate, the thickness of the outer peripheral portion is greater than a thickness of a portion extending from the outer peripheral portion to the center side.

3. The sealed battery according to claim 1,
wherein the thickness of the outer peripheral portion of the lid plate is greater than a penetration depth of a welding portion between the lid plate and the outer can.

4. The sealed battery according to claim 1,
wherein in the lid plate, a concave portion is formed on a surface positioned inside the battery case such that the thickness of the outer peripheral portion is greater than the thickness of the portion covering the electrode body.

5. The sealed battery according to claim 4,
wherein on the surface of the lid plate positioned inside the battery case, a tapered portion is formed between the outer peripheral portion and the portion extending from the outer peripheral portion to the center side such that the thickness of the lid plate increases toward the outer peripheral portion.

6. The sealed battery according to claim 1,
wherein the battery case has a flat shape in which a pair of opposite surfaces are formed to be wider than other surfaces,
the opening is formed on one of the pair of surfaces in the battery case, and
the lid plate is fixed to the outer can by welding so as to configure the opening-formed surface of the battery case.

7. The sealed battery according to claim 1,
wherein in the outer peripheral portion of the lid plate, a groove is formed on a surface positioned outside the battery case, and
in the lid plate, a portion extending from the groove to the outer periphery side is welded to the edge portion.

8. The sealed battery according to claim 1,
wherein the outer can and the lid plate are welded to each other by laser beams.
